(19) United States
(12) Patent Application Publication
(10) Pub. No.: US 2018/0036198 A1
(43) Pub. Date: Feb. 8, 2018

(54) MASSAGE DEVICE FOR A VEHICLE SEAT

(71) Applicant: BROSE FAHRZEUGTEILE GMBH & CO. KOMMANDITGESELLSCHAFT, COBURG, Coburg (DE)

(72) Inventors: Christian MERGL, Zeil/Main (DE); Jochen HOFMANN, Marktgraitz (DE); Christoph SINGER, Coburg (DE); Ulf HARTMANN, Bamberg (DE); Gregor KROENER, Bischberg (DE)

(21) Appl. No.: 15/554,687

(22) PCT Filed: Mar. 9, 2016
(86) PCT No.: PCT/EP2016/054956

§ 371 Date: Oct. 20, 2017

(30) Foreign Application Priority Data
Mar. 12, 2015 (DE) 10 2015 204 492.0

(51) Int. Cl. A61H 23/00; A61H 23/02; B60N 2/44

(52) U.S. Cl. CPC A61H 23/004; B60N 2/448; A61H 23/02; A61H 2203/0431; A61H 2201/1207; A61H 2201/1623; A61H 2201/149; A61H 2201/0149; A61H 2201/1664; A61H 2201/1215

(57) ABSTRACT

It is provided a massage device for a vehicle seat having at least one massage element, which moves a contact surface of the vehicle seat by means of an electromechanical actuator for the purpose of massaging a person in the vehicle seat. The massage element has a spring element, whereof the shape can be altered with respect to the contact surface of the vehicle seat by a restoring element containing the electromechanical actuator.

### CROSS-REFERENCE TO A RELATED APPLICATION

This application is a National Phase Patent application of International Patent Application Number PCT/EP2016/054956, filed on Mar. 9, 2016, which claims priority of German Patent Application Number 10 2015 204 492.0, filed on Mar. 12, 2015, the contents of both of which are incorporated herein by reference.

### BACKGROUND

The invention relates to a massage device for a vehicle seat.

Massage devices for vehicle seats are known, which comprise lumbar supports which are moved for example in an oscillating manner and are electromotively or pneumatically operated. Rollers which are arranged in the backrest of a vehicle seat and can be moved up and down are also used as massage devices. However, pneumatic systems have essentially become established, in which air cushions are mounted closely below the surface of the seat part or the backrest of a vehicle seat and can be filled and emptied individually in a controlled manner. A high number of such air cushions in conjunction with corresponding control devices enable different massage effects to be achieved via the support or surface which faces a user of the seat.

DE 10 2012 024 854 A1 discloses a motor-vehicle seat having a foam layer, a cover and a massage device, which has massage elements which are formed as fluid-fillable hollow bodies and are arranged in recesses in the foam layer which open towards the cover. To generate the necessary mechanical force effect on the cover for the massage effect, the hollow bodies expand when filled with fluid and are supported here against a supporting element which faces away from the cover and is arranged such that it introduces the mechanical forces which result from the expansion of the hollow bodies and are directed away from the cover into the foam layer.

DE 41 08 323 A1 discloses a massage device in which a plurality of massage elements formed as unbalance motors generate the massage effect. The massage device has a mat in which cavities, in which the unbalance motors are arranged, are produced by quilting a material or synthetic leather. The mat is fastened to a vehicle seat and connected to a current source via a control device.

The disadvantage of the known massage devices is the considerable spatial or installation-space requirement for arranging the massage elements and the complex and fault-prone construction.

### SUMMARY

The object of the present invention is to provide a massage device for a vehicle seat of the type mentioned at the outset, which is notable for a small spatial requirement and low manufacturing costs and for a simple, functionally-reliable and durable construction using standardized components.

This object is achieved according to the invention by a massage device with features as described herein.

The inventive solution of composing massage elements from a spring element and a restoring element containing the electromechanical actuator, which alters the shape of the spring element with respect to the contact surface of the vehicle seat and, in particular, returns the spring element into a starting position from which, after being enabled by the restoring element, it alters its shape into an end or intermediate position as a result of a spring force, is notable for a small spatial requirement and low manufacturing costs and for a simple, functionally reliable and durable construction using standardized components.

The invention starts with the realization of using simple elements such as pressure springs, tension springs, torsion springs, helical springs or leaf springs for massaging a vehicle occupant in a vehicle seat, which are compressed, expanded or deflected by a restoring element having an electromechanical actuator so that the massage effect on the vehicle occupant is exerted by the spring element, whilst the restoring element restores it into the starting position, i.e. into a compressed, expanded or bent position.

As a result of using a standardized spring element, the construction of the massage device is very simple since springs are mass-produced articles and can therefore be used economically. If misuse-induced loads act on the massage element composed of a spring element and a restoring element, the massage element is not damaged since the misuse-induced forces acting from the direction of the vehicle occupant simply cause the spring element to be compressed to block size so that the function of the massage element is not impaired.

The term “spring elements” is used to refer to resilient components which, in addition to pressure springs, tension springs, torsion springs, helical springs or leaf springs, also include adjustable components, such as spring or comfort mats, hydraulic buffers (shock absorbers), rubber buffers or the like, which can be elastically adjusted from a starting position into a compressed, expanded or bent end or intermediate position.

The spring element preferably exerts a massage pressure on the contact surface of the vehicle seat during the transition from its tensioned state into its relaxed state, and is returned to the tensioned state by means of the restoring element.

The division of the massage element into a spring element and a restoring element enables both a spatially separate arrangement of the spring element and the restoring element, and therefore an arrangement of the functional elements of the massage element which is adapted to the spatial properties of a vehicle seat, and also the condition for reducing functional elements, for example as a result of restoring a plurality of spring elements into their starting position by means of a single restoring element. When the massage device of a vehicle seat is divided into a plurality of massage zones, for example, it is thus possible to set different massage functions by means of a cross-zone actuation of a plurality of spring elements by means of one restoring element.

The restoring element can have actuators in different forms. In a first variant, the restoring element contains an electromotive drive and a coupling element for connecting the output of the electromotive drive to the spring element for altering the expansion of the spring element, wherein the electromotive drive preferably comprises a self-inhibiting gear and an electric motor. The coupling element can comprise for example a pull cable connected to one end of the spring element and to the electromechanical actuator.

This basic configuration of a restoring element having an electromotive drive can be varied in different ways. In a first variant, the restoring element has a slip clutch, which is driven by a continuously operated electric motor, and a pull cable which is connected to the slip clutch and the spring element so that, with a continuously running electric motor, the spring element is alternately contracted to its block size and is relaxed again when the clutch slips.

In a second variant, the restoring element comprises a conical cable roller, which is driven by an electric motor, and a pull cable which can be wound and unwound on the cable roller in a manner guided along the lateral surface of the conical cable roller and is connected to one end of the spring element, so that the spring element is compressed in one direction of rotation of the electric motor and expands in the other direction of rotation.

In a third variant, the restoring element has a pull cable which is connected to one end of the spring element and to a cable-winding device, which is formed in such a way that the pull cable can be wound and unwound unevenly to generate a vibration massage effect. Therefore, in this variant, a vibration effect is thus achieved in that the cable-winding device is formed unevenly so that, with an electric motor rotating at a constant speed, the pull cable is wound and unwound unevenly and the spring element is thus compressed and expanded unevenly.

In a fourth variant, the restoring element contains a pull cable, which is connected to one end of the spring element and can be wound and unwound on a spindle driven directly by an electric motor or via a flexible spindle.

In a fifth variant, the restoring element has a spindle nut, whereof the internal thread meshes with the windings of a spring element formed as a cylinder spring or helical spring and whereof the external thread meshes with a gearwheel driven by an electric motor in such a way that the cylinder spring is moved back and forth.

Instead of an electromotive drive and a coupling element for restoring the spring element into its starting position, a moving coil magnet can be used as the restoring element, whereof the coil is connected to one end of the spring element in such a way that, as a result of a magnetic alternating field generated when a current flows through the coil, the coil connected to the spring element is moved upwards and downwards within the static magnetic field generated by the static magnet of the moving coil.

The basic configuration of the massage element having a spring element and a restoring element restoring the spring element into its starting position enables a plurality of spring elements to be connected to a common electromechanical actuator via coupling elements associated with said spring elements, so that a plurality of massage elements only require one electromechanical actuator. This further reduces the spatial requirement of the massage device and the manufacturing costs thereof.

A first variant of a massage device having a plurality of spring elements and a common electromechanical actuator comprises a restoring element which has a pull cable which is connected to an electromotive drive via a winding shaft and whereof the ends are connected to at least two spring elements in such a way that, upon actuation of the electromotive drive, the extension of the spring elements with respect to the contact surface of the vehicle seat is altered in a mutually opposed direction.

In a second variant, a plurality of spring elements are connected to a respective restoring element, which has a pull cable, which is connected to one end of the spring elements and can be wound and unwound on a shaft, and a switchable clutch, which connects the shaft to an electromotive drive.

Active or passive locking can be provided for arresting inactive spring elements. With active locking, the spring element is arrested by a locking element in a position which is pre-tensioned by means of the restoring element, which locking element is preferably actuated in the manner of a lock or a braking device by an electromechanical actuator. Alternatively, passive locking of inactive spring elements of the massage device can be provided by means of a push-push locking mechanism, in which, according to the principle of a ball-point pen, a spring-loaded latching pin moves via a cardioid mechanism and is alternately extended and retracted so that the spring element is alternately blocked or enabled.

Instead of an electromotive drive or a moving coil drive as the electromechanical actuator for restoring the spring elements of massage elements, an electromechanical actuator can be used which at least partially comprises a shape memory alloy or a memory metal and executes changes in shape owing to the shape memory effect. By heating a component comprising a shape memory alloy here, for example as a result of a controlled current flow through the component, it is possible to make use of both the one-way memory effect and the two-way memory effect. With the one-way memory effect, a single change in shape, for example a shortening, of the component takes place as it is heated and a return to its cold shape takes place by means of a restoring element which, in the present application, comprises the spring element which was previously compressed, expanded or bent during the shortening of the component comprising the shape memory alloy. With the two-way memory effect, a component comprising a shape memory alloy assumes predetermined shapes at high and low temperatures, which are effected by a shape memory wire, for example, as a result of a controlled current flow.

In a first variant of an electromechanical actuator comprising a shape memory alloy, the restoring element has a pull cable whereof one end is connected to one end of the spring element and whereof the other end is connected to a component comprising a shape memory alloy which can be connected to a current source in such a way that the component contracts when a current is applied and expands when a current is not applied for the purpose of contracting and extending the spring element, wherein the component comprises for example a shape memory wire or a deflection or articulated lever and a shape memory wire connected thereto.

In a second variant, the restoring element comprises a spring steel element and a component which is connected to the ends of the spring steel element and comprises a shape memory wire which contracts when a current is applied and expands when a current is not applied. In a preferred embodiment in this regard, the component has a lever kinematics having two first levers connected in an articulated manner to the ends of the spring steel element and second levers connected in an articulated manner to the first levers and linkages on the solid structure of the vehicle seat, and having the shape memory wire connecting the first levers to one another.

The spring element can comprise different materials and different constructions. The choice of a suitable spring element depends substantially on the field of use of the respective massage element of the massage device and its mode of operation.

In a first embodiment, the spring element comprises a pressure spring, tension spring, torsion spring or leaf spring. To meet the request for a minimal spatial requirement, the spring element preferably has a minimal block size resulting from
alternately large and small winding diameters,
a conical spring form, whereof the windings can be pressed into one another,
a frustoconical spring form having a block length corresponding to the winding diameter or is embedded in a depression in a lumbar shield of the vehicle seat.

In a second embodiment, the spring element comprises an elastic element of a sprung base of the vehicle seat, whereof the shape can be altered by means of the restoring element, preferably a comfort mat of the vehicle seat, whereof one end is connected to a joint and whereof the other end is connected to a spindle nut of a spindle driven by an electric motor in such a way that, as a result of a rotation of the spindle, the spindle nut moves along the spindle and the comfort mat becomes curved or elongated.

In addition to their use in massage devices of a vehicle seat, the massage elements can be used as sensors for seat-occupancy detection and/or as spring elements of the seat and/or backrest pad of the vehicle seat in the manner of a sprung mattress.

The massage elements can furthermore be controlled in such a way that, in the event of a collision, they at least partially absorb the rebound energy of a person in the vehicle seat. There is moreover the option of pre-setting the massage elements individually in such a way that the contour of the vehicle seat can be adapted to a person using the vehicle seat.

Since a necessary control circuit is required to trigger different massage functions, this can also be used in addition to the massage function for actively compensating vehicle vibrations and thus increasing the seat comfort.

As a result of its small spatial requirement and its simple, functionally reliable construction, the massage device according to the invention can be used in any region of a vehicle seat, for example in the pad structure of a seat part or a backrest of the vehicle seat and/or in side bolsters of a seat part, a backrest or a head rest of the vehicle seat and/or in a device for lumbar adjustment of a vehicle seat and/or in a thigh support of a vehicle seat.

### BRIEF DESCRIPTION OF THE DRAWINGS

The idea on which the invention is based will be explained in more detail below with reference to the exemplary embodiments illustrated in the figures of the drawing.

FIG. 1 shows an isometric illustration of a vehicle seat having massage devices in the seat part, the backrest and head rest with massage elements arranged in a distributed manner.

FIG. 2 shows a schematic illustration of a massage element having a spring element, an electromechanical actuator and a coupling element.

FIG. 3 shows a schematic longitudinal section through a massage element embedded in a lumbar shield of a vehicle seat.

FIGS. 4 and 5 show schematic illustrations of a massage element having a locking pin for locking a spring element.

FIG. 6 shows a schematic illustration of a massage element having a spring element and a restoring element with a continuously running electromotive drive and a slip clutch.

FIG. 7 shows a schematic illustration of a massage element having a spring element and a restoring element with an electromotive drive and a conical cable roller for winding and unwinding a pull cable.

FIG. 8 shows a schematic illustration of a massage element having a spring element and a restoring element with a spindle for winding and unwinding a coupling element formed as a pull cable and a flexible connection between the spindle and an electromotive drive.

FIG. 9 shows a schematic illustration of a massage element having a bending lever integrated in a comfort mat as a spring element and a restoring element formed as a spindle drive.

FIG. 10 shows a schematic diagram of a dual massage element having two spring elements and a common restoring element.

FIG. 11 shows a schematic diagram of a dual massage element having two spring elements and two coupling elements driven by an electromotive drive with a switchable clutch.

FIG. 12 shows a schematic illustration of a massage element having a spring element formed as a helical spring and a spindle nut which is driven by an electric motor and adjusts the helical spring.

FIG. 13 shows a schematic illustration of a massage element having a spring element and a restoring element formed as a moving coil magnet drive; and

FIGS. 14 to 19 show schematic illustrations of three variants of a massage element having a spring element in a respective starting and activation position and a restoring element having an actuator formed as a component comprising a memory shape alloy.

### DETAILED DESCRIPTION

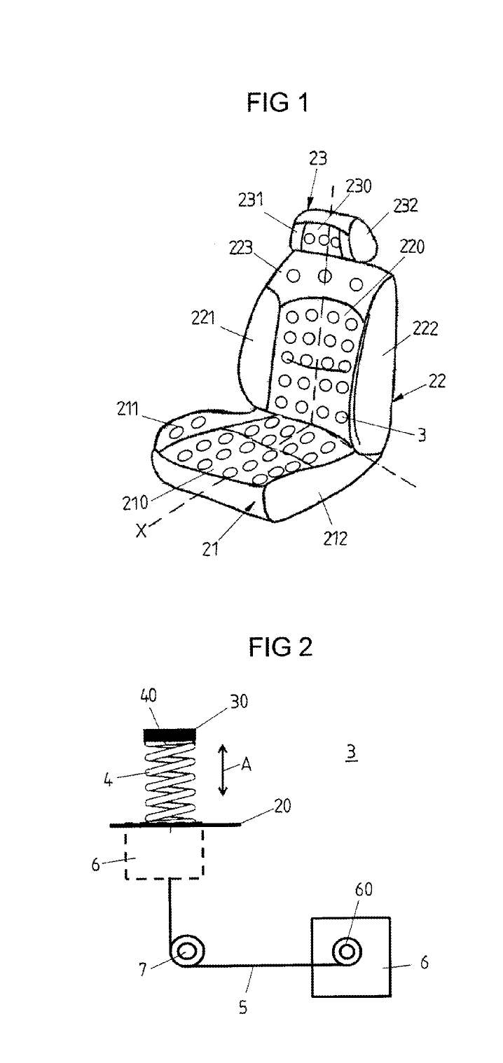

FIG. 1 shows, in a perspective illustration, a vehicle seat 2 having a seat part 21 having a seat surface 210 and laterally elevated side bolsters 211, 212, a backrest 22 having a central seat-back surface 220, laterally elevated side bolsters 221, 222 and a shoulder cushion 223 as well as a head rest 23 having a central contact surface 230 and lateral head supports 231, 232. Massage elements 3 of a massage device are arranged below the bearing surfaces of the seat part 21 and/or the back rest 22 and/or the head rest 23, which are covered with a material or with leather, which massage elements are controlled by a control device (not illustrated in more detail), wherein the massage elements 3 are arranged in groups in massage zones and can be activated individually or in groups for executing pre-set massage functions. For example, the massage elements 3 which are arranged behind or above one another along the central longitudinal axis x of the vehicle seat 2 can be actuated in succession to generate a wave-like massage effect.

The schematic-perspective illustration of FIG. 1 already shows that, for carrying out a plurality of massage functions and for contacting large body parts of a user of the seat, it is necessary to provide a multiplicity of massage elements, which involves a corresponding spatial requirement. For this reason, it is desirable for the massage elements 3 to have the smallest spatial requirement possible, whilst enabling functionally reliable operation and economical manufacture.

As an additional function to the execution of massage functions, the arrangement of a multiplicity of massage elements 3 moreover enables the contours of the seat part and the backrest of the vehicle seat to be finely adjusted in a manner aligned individually to the physique of a user of the seat.

FIG. 2 shows, in a schematic, partially perspective illustration, the essential construction of a massage element 3 according to the invention, which is composed of a spring element 4, for example in the form of a pressure spring, and a restoring element 5, 6, 7 having an electromechanical actuator 6, a coupling element 5 formed for example as a pull cable and a deflection roller 7 provided as required. The coupling element or the pull cable 5 is connected at a cable fastening 40 to a massage surface 30 of the vehicle seat, which forms one end of the spring element 4 whilst the other end of the spring element 4 is supported on the solid structure 20 of the vehicle seat.

FIG. 2 shows the spring element 4 formed as a pressure spring in an expanded state. By actuating the electromechanical actuator 6, for example a self-inhibiting electromotive drive connected to a winding shaft 60, the pull cable 5 is wound onto the winding shaft 60 so that the massage surface 30 is pulled in the direction of the solid structure 20 of the vehicle seat and the pressure spring 4 is thereby brought into a compressed state.

If the electromotive drive 6 is deactivated or operated in the opposite direction of rotation, the pressure spring 4 relaxes and returns to its expanded state as a result of its spring force. By alternately winding and unwinding the pull cable 5 and compressing and expanding the pressure spring 4 as a result, a movement of the massage surface 30 is generated in the direction of the double-headed arrow A, and with this a massage effect by means of the massage element 3.

By attaching the pull cable 5 to the winding shaft 60 of the electromotive drive 6 via one or more deflection rollers 7, it is possible to place the electromotive drive 6 as desired in the vehicle seat and to connect an electromotive drive to a plurality of pressure springs 4. Alternatively, to actuate the pull cable 5, the electromotive drive 6 or another type of electromechanical actuator can be connected to the solid structure 20 of the vehicle seat directly in the elongation of the pressure spring 4 according to the illustration shown by dashes in FIG. 2.

The spatial requirement of the massage element due to its composition comprising a spring element 4 and a restoring element 5, 6, 7 can be further reduced as a result of additional constructive measures, in particular as a result of a minimal block size of the spring element 4, which can be achieved by alternately large and small winding diameters, the conical spring form of the spring element, whereof the windings can be pressed into one another, or by forming the spring element as a frustoconical spring having a block size corresponding to the winding diameter.

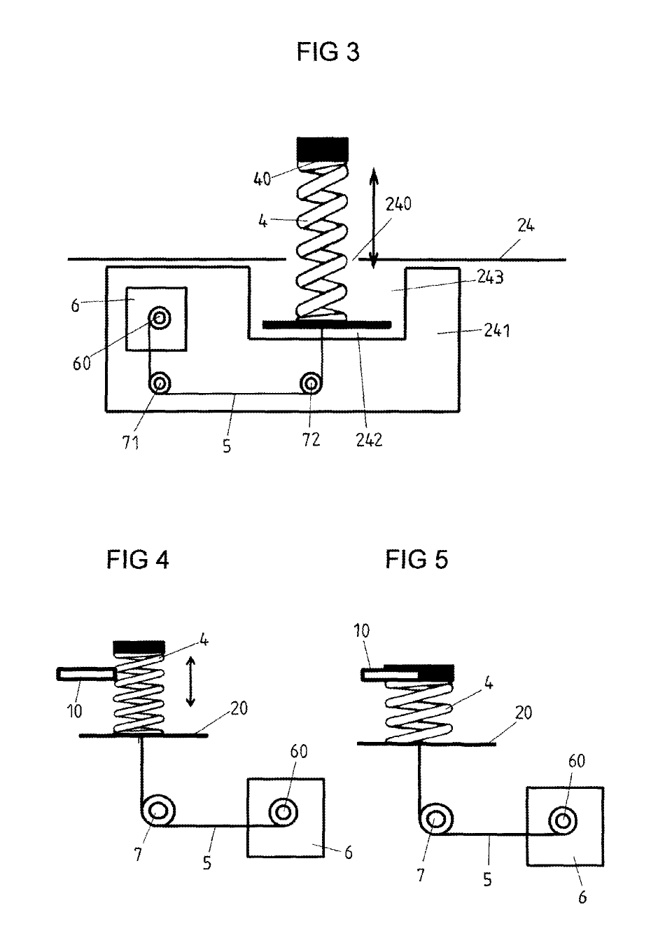

A very small effective block size can also be achieved according to the schematic illustration in FIG. 3 in that the spring element 4 is embedded in a lumbar shield 24 of a vehicle seat, whereby it is pushed through an opening 240 in the lumbar shield 24 and its one end is placed on a spring bearing 242 at the base of a recess 243 of a housing 241 arranged behind the lumbar shield 24. The electromotive drive 6 arranged in the housing 241 serves, as described above, for actuating a pull cable 5 as a coupling element which is connected by its other end to a cable fastening 40 of the spring element 4 and is guided to the electromotive drive 6 via two deflection rollers 71, 72.

To arrest an inactive spring element 4 in the tensioned, i.e. in the compressed, expanded or bent, state, active locking by means of an additional locking element 10, for example in the form of a locking pin, can be provided according to FIGS. 4 and 5, which locking element, after the contraction of the spring element 4 from the relaxed state illustrated in FIG. 4 into the compressed state illustrated in FIG. 5, is moved into the travel path of the spring element 4 by means of an actuator and blocks the spring element 4 in its block size.

Alternatively to being formed as a locking pin, the additional locking element 10 can be formed in the manner of a lock or a braking device and can be actuated by an electromechanical actuator. Instead of an active locking of the spring element 4, passive locking of an inactive spring element 4 can be provided by means of a push-push locking mechanism, in which, according to the principle of a ball-point pen, a spring-loaded latching pin moves via a cardioid mechanism and is alternately extended and retracted so that the spring element is alternately blocked or enabled.

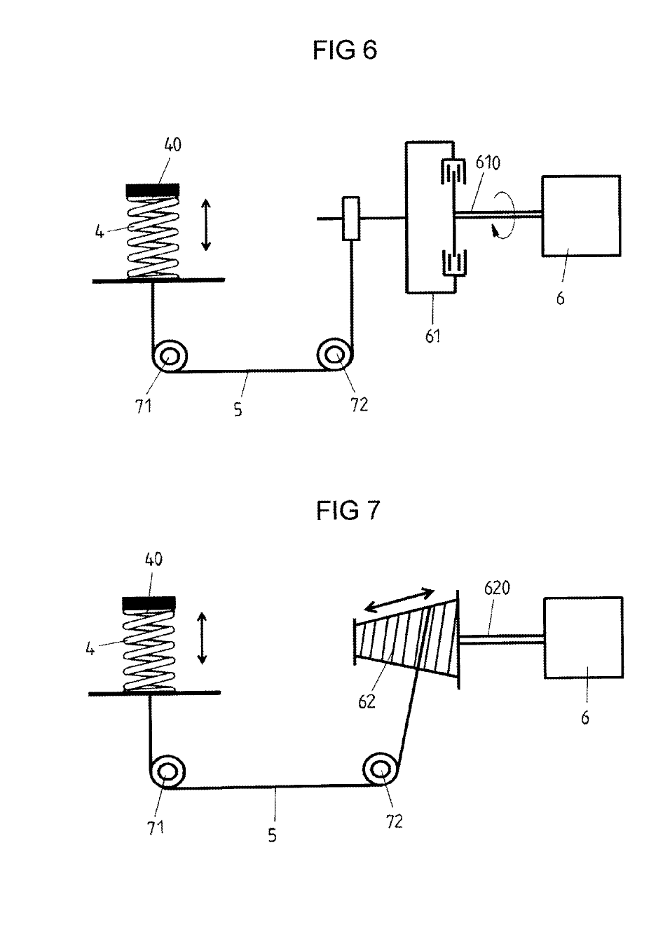

Alternatively to the exemplary embodiments explained above, and for executing various massage functions, it is possible to realize a different manner of restoring spring elements 4 into their starting position. Examples of this are illustrated in FIGS. 6 to 9, which are described below.

FIG. 6 shows, in a schematic illustration, a massage element which comprises a spring element 4 formed as a pressure spring and a restoring element which comprises a pull cable 5, which is connected to a cable fastening 40 of the pressure spring 4, guided over deflection rollers 71, 72 and connected to the output of a slip clutch 61, and an electric motor 6, whereof the motor shaft 610 is coupled to the drive side of the slip clutch 61. The continuously running electric motor 6 rotates the slip clutch 61 so that the pull cable 5 connected to the output of the slip clutch 61 and the cable fastening 40 contracts the pressure spring 4. If this is compressed to block size, the torque transmitted via the slip clutch 61 exceeds a predetermined value so that this latter slips, whereupon the pressure spring 4 relaxes again and the torque transmitted via the slip clutch 61 decreases. If the torque decreases to below a pre-set value, the slip clutch 61 transmits a tensile force again via the pull cable 5 to the pressure spring 4, which is again compressed.

By setting a hysteresis between the torque which leads to the slipping of the slip clutch 61 and the torque at which the slip clutch 61 again transmits a tensile force to the pull cable 5, and through the dimensioning of the pressure spring 4, it is possible to set the switching frequency of the pressure spring 4 and therefore the massage frequency with a continuously running electric motor 6.

FIG. 7 shows an embodiment of a restoring element, which is notable in that the electric motor 6 delivers a constant torque. In this embodiment, the pull cable 5, which is guided with a cable fastening 40 at one end of a spring element 4, which is likewise formed as a pressure spring, and via deflection rollers 71, 72, is wound and unwound on a conical cable roller 62 which is connected to the electric motor 6 via a motor shaft 620. The pull cable 5, which is guided from the large diameter to the small diameter of the conical cable roller 62, therefore compensates the spring force which rises with the increasing compression of the pressure spring 4, so that, with a constant torque, the electric motor 6 contracts the pressure spring 4 until, upon reaching the small diameter of the conical cable roller 62, the block size of the pressure spring 4 is reached and, by reversing the direction of rotation of the electric motor 6, the pressure spring 4 is relaxed again as a result of the spring force.

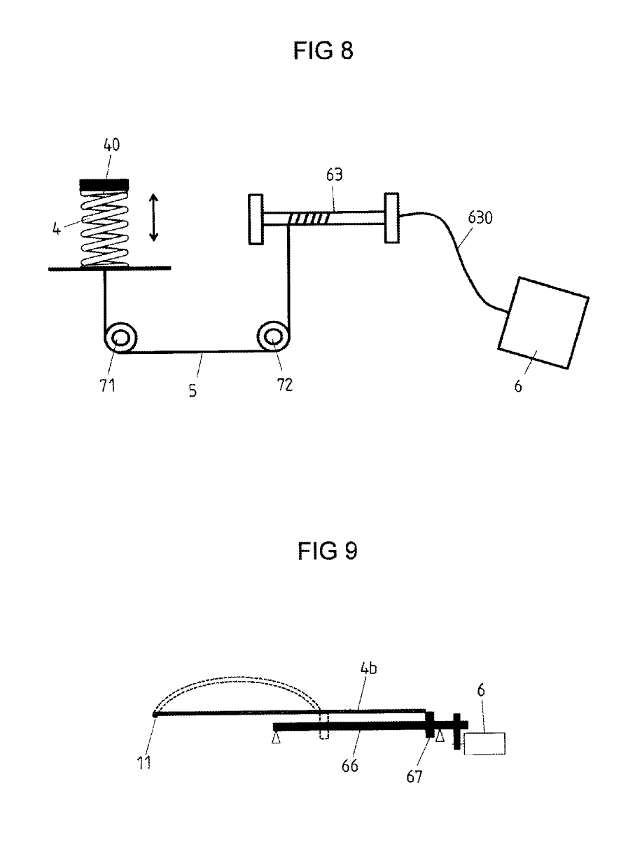

In the embodiment of a massage element which is illustrated schematically in FIG. 8, a pull cable 5, which is used as a coupling element, is connected to a cable fastening 40 at the end of a spring element 4 formed as a pressure spring and is guided via deflection rollers 71, 72, is wound onto a preferably axially movable spindle 63, which is supported at its one end on an axial slide bearing and connected at its other end to a spindle nut and is driven by an electric motor 6 via a flexible spindle 630. By rotating the spindle 63 in one direction of rotation, the pressure spring 4 is tensioned as a result of winding the pull cable 5 onto the axially moving windings of the spindle 63 and, when the spindle 63 is rotated in the opposite direction of rotation, the pressure spring 4 is relaxed again into its starting position as a result of unwinding the pull cable 5 off the windings of the spindle 63.

FIG. 9 shows, in a schematic illustration, a bending lever 4b which is integrated in a comfort mat and becomes curved or elongated by means of a spindle drive 66, 67. In this embodiment, the bending lever 4b of the comfort mat is connected at its one end to a material joint 11 and at its other end to a spindle nut 67, which is moved along a spindle 66 rotated in one or the other direction of rotation by an electromotive drive having an electric motor 6. In the one end position of the spindle nut 67, the bending lever 4b of the comfort mat assumes the shape illustrated in continuous lines, whilst, in the other direction of rotation or in intermediate positions, the bending lever 4b of the comfort mat is curved along the dashed line.

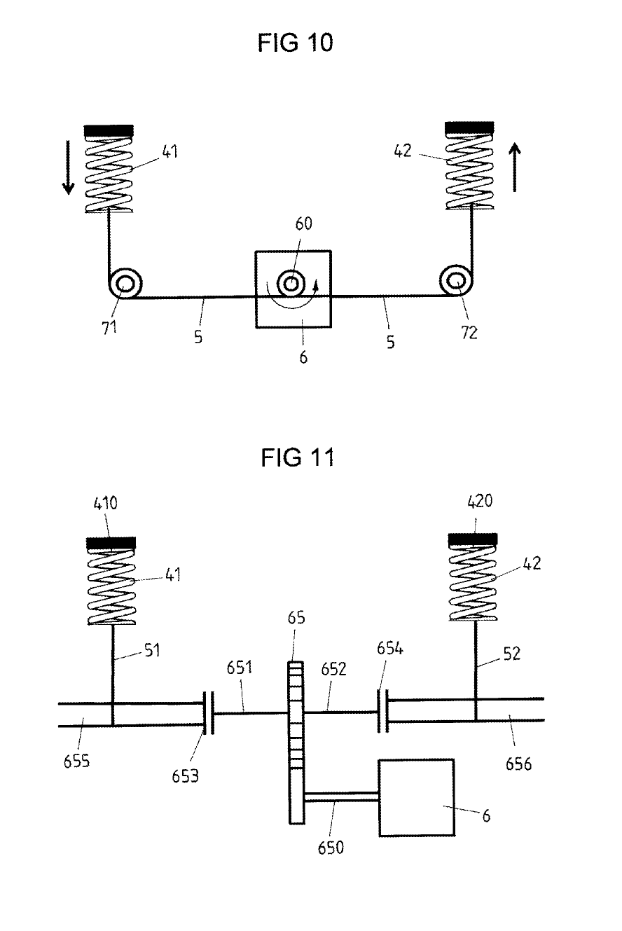

As explained above, the inventive solution of the composition of a massage element comprising a (passive) spring element and an actively actuated restoring element enables a plurality of spring elements to be restored to their starting position by means of a single restoring element. Examples of this are illustrated in FIGS. 10 and 11 described below.

FIG. 10 shows, in a schematic illustration, an exemplary embodiment in which two spring elements 41, 42 formed as pressure springs are connected to the winding shaft 60 of an electric motor 6 via pull cables 51, 52. Through an anti-clockwise rotation of the electric motor 6 in the direction of rotation B shown in FIG. 9, the one pull cable 51 is wound and the other pull cable 52 is unwound, so that the one pressure spring 41 is compressed and the other pressure spring 42 is released to decompress or return to the starting position. In the opposite, clockwise, direction of rotation, the pull cable 52 is wound and the pressure spring 42 is therefore compressed whilst the pull cable 51 is unwound and the pressure spring 41 is therefore relaxed. Accordingly, by alternating the directions of rotation of the electromotive drive 6, the spring elements 41, 42 of two massage elements can be restored into their starting positions via the pull cables 51, 52 formed as coupling elements.

FIG. 11 shows, in a schematic illustration, an exemplary embodiment in which, by means of two pull cables 51, 52, two spring elements formed as pressure springs 41, 42 can be wound and unwound on winding shafts 655, 656 which are connected via a respective switchable clutch 653, 654 to two drive shafts 651, 652 of a gear device 65 which has a pinion connected to the motor shaft 650 of an electric motor 6 and a gearwheel connected to the drive shafts 651, 652. The pull cables 51, 52 attached to spring fastenings 410, 420 guide the pressure spring 41, 42 associated therewith back into its starting position when the respective winding shafts 655, 656 are coupled via the associated switchable clutch 653, 654 associated therewith to the motor shaft 650 of the electric motor 6.

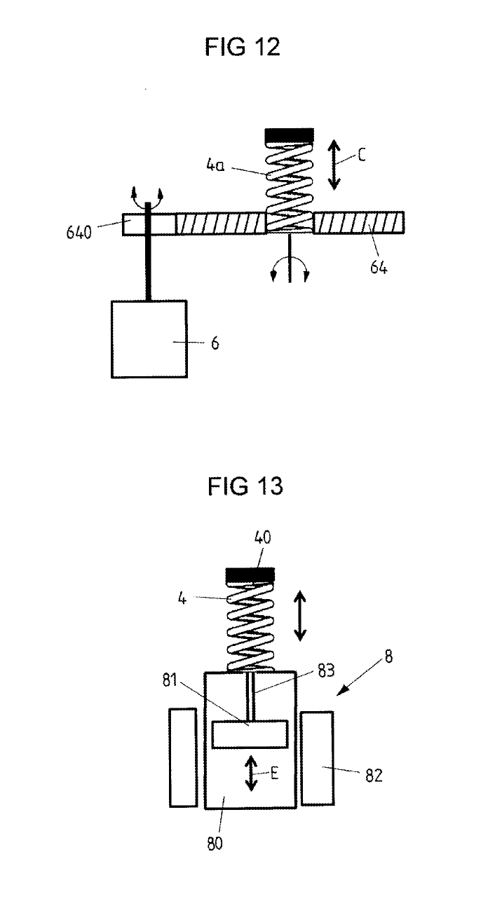

The exemplary embodiments described above form the basis of a restoring element having an electromechanical actuator, which comprises an electromotive drive and a winding shaft, and a pull cable which may be wound and unwound on the winding shaft for the purpose of restoring the spring element, formed as a pressure spring, tensile spring, torsion spring or leaf spring, into its tensioned, i.e. compressed, expanded or bent, starting position. Alternatively, it is also possible to use other electromechanical actuators, of which examples are illustrated in FIGS. 12 to 19, which are explained in more detail below.

FIG. 12 shows, in a schematic illustration, an electromechanical actuator formed in the manner of a spindle drive with a spring element formed as a helical spring 4a, whereof the helical windings mesh with the internal thread of a spindle nut 64 whereof the external thread is engaged via a gearwheel 640 connected to the motor shaft of an electric motor 6. By rotating the electric motor in one or the other direction of rotation, the helical spring 4a is moved upwards or downwards in the direction of the double-headed arrow C according to FIG. 11 and thereby generates a massage effect which is promoted by the additional spring effect of the helical spring 4a.

FIG. 13 shows, in a schematic illustration, an electromagnetic actuator which is formed as a moving coil magnet 8 and comprises a permanent magnet 82 and a coil 81, to which an alternating field is applied and which is connected via a coupling rod 83 to the one end of a spring element 4 formed for example as a pressure spring, whereof the other end is supported on a housing 80 of the moving coil magnet 8. As a result of the alternating current flow through the coil 81 and the resultant increasing and decreasing magnetic alternating field, the coil 81 is moved in one or the other direction according to the double-headed arrow E so that the pressure spring 4 is compressed in the one direction and relaxed in the other direction.

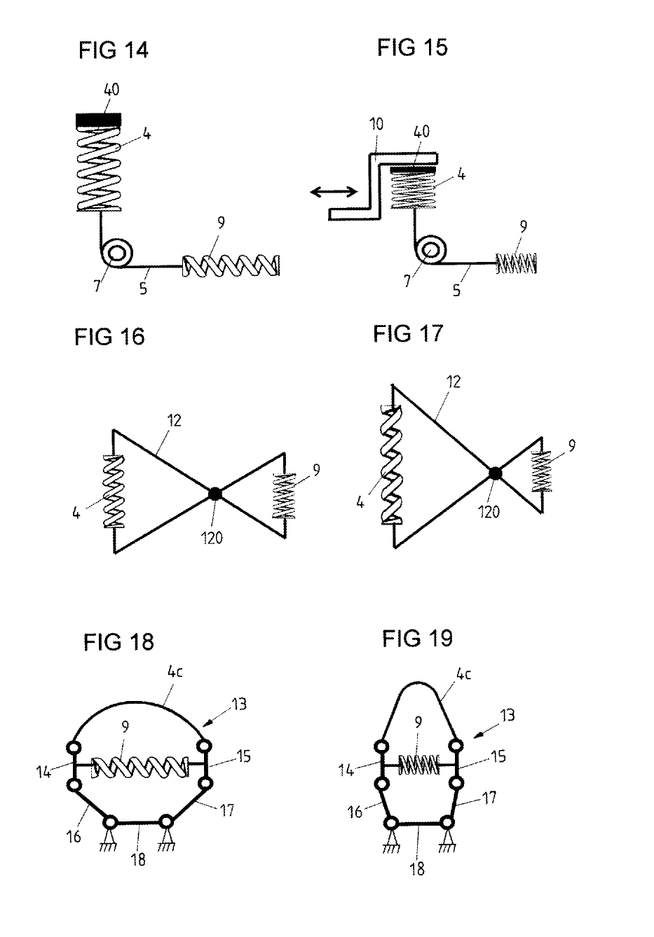

A particular drive type comprises an electromechanical actuator which uses the shape memory effect of shape memory alloys or so-called memory metals, so that an electric motor with a gear unit and a pull cable as a coupling element for restoring spring elements is omitted, resulting in a further reduction in the installation space required for massage elements. Examples of restoring elements having an electromechanical actuator comprising a memory metal are illustrated in FIGS. 14 to 19 and described in more detail below.

In the simplest embodiment illustrated in FIG. 14, the massage element comprises a spring element 4, which, on the one hand, is supported on the solid structure of the vehicle seat and, on the other, is connected to a pull cable 5 via a cable fastening 40, and a restoring element, which comprises an actuator formed as a shape memory wire 9 and a pull cable 5 as a coupling element. The pull cable 5 is connected via a deflection roller 7 to the shape memory wire 9, which contracts when heating causes a change in shape which represents for example a shortening of the shape memory wire 9, and compresses the pressure spring 4 at the most to block size via the connection of the pull cable 5 to the cable fastening 40. The heating of the shape memory wire 9 can be generated for example by a current flowing through the shape memory wire 9 so that, when the current flow is interrupted, the shape memory wire 9 cools, assumes its original length again and the pressure spring 4 is thereby relaxed. By applying a current to the shape memory wire 9 at intervals, an oscillating movement of the pressure spring 4 is thereby generated in conjunction with the restoring force of the pressure spring 4 in order to generate a massage effect.

By activating a locking element 10 when a current flows through the shape memory wire 9, the pressure spring 4 can be blocked in the shape in which it is maximally contracted to block size according to the schematic illustration according to FIG. 15 and relaxed again after the current flow through the shape memory wire 9 has ended, when the locking element 10 is retracted.

In FIGS. 16 and 17, an embodiment of the basic principle of a massage element illustrated in FIGS. 14 and 15 is illustrated with a restoring element containing a shape memory alloy, in which the spring element 4 is connected at its ends to the one ends of a deflection or articulated lever 12 having a pivot joint 120, the other ends of which are connected to the ends of a shape memory wire 9. When a current flows through the shape memory wire 9, this contracts according to FIG. 17 so that the ends of the deflection or articulated lever 12 which are connected to the spring element 4 are drawn apart and the spring element 4 is thereby moved from its starting position illustrated in FIG. 16 into the expanded position illustrated in FIG. 17.

A further embodiment illustrated schematically in FIGS. 18 and 19 has a hexagonal lever kinematics 13, in which a spring steel forming the spring element 4c of a massage element forms a lever of the lever kinematics 13, whereof the ends are connected to first levers 14, 15, the second ends of which are connected in an articulated manner to two levers 16, 17, which are connected to one another either at the solid structure of a vehicle seat or via a third lever 18. The first levers 14, 15 are connected to one another via a shape memory wire 9, which can be connected to a voltage source in a controlled manner for altering the lever kinematics, so that the lever kinematics 13 assumes the shape illustrated schematically in FIG. 18 with the relaxed spring element 4c formed as spring steel or, when a current flows through the shape memory wire 9, the shape illustrated in FIG. 19 with the strongly bent spring steel element 4c.

### LIST OF REFERENCE SIGNS

2 Vehicle seat
3 Massage element
4 Spring element
4a Helical spring
4b Bending lever
4c Spring element
5 Coupling element
6 Electromechanical actuator
7 Deflection roller
8 Moving coil magnet
9 Shape memory wire
10 Locking element
11 Material joint
12 Deflection or articulated lever
13 Lever kinematics
14, 15 First lever
16, 17 Second lever
18 Third lever
20 Solid structure of the vehicle seat
21 Seat part
22 Backrest
23 Head rest
24 Lumbar shield
30 Massage surface
40 Cable fastening
41, 42 Spring elements
51, 52 Pull cables
60 Winding shaft
61 Slip clutch
62 Conical cable roller
63 Axially movable spindle
64 Spindle nut
65 Gear device
66 Spindle
67 Spindle nut
71, 72 Deflection rollers
81 Coil
82 Permanent magnet
83 Coupling rod
120 Pivot joint
210 Seat surface
211, 212 Side bolsters
220 Central seat-back surface
221, 222 Side bolsters
223 Shoulder cushion
230 Central contact surface
231, 232 Lateral head supports
240 Opening
241 Housing
242 Spring bearing
243 Recess
410, 420 Spring fastenings
610, 620 Motor shaft
630 Flexible spindle
640 Gearwheel
651, 652 Drive shaft
653, 654 Switchable clutch
655, 656 Winding shaft

1.-33. (canceled)

34. A massage device for a vehicle seat having at least one massage element, which moves a contact surface of the vehicle seat by means of an electromechanical actuator for the purpose of massaging a person in the vehicle seat, wherein the massage element has a spring element, whereof the shape can be altered with respect to the contact surface of the vehicle seat by a restoring element containing the electromechanical actuator.

35. The massage device as claimed in claim 34, wherein the spring element exerts a massage pressure on the contact surface of the vehicle seat during the transition from its tensioned state into its relaxed state, and is returned to the tensioned state by means of the restoring element.

36. The massage device as claimed in claim 34, wherein the restoring element has an electromotive drive and a coupling element for connecting the output of the electromotive drive to the spring element for altering the expansion of the spring element.

37. The massage device as claimed in claim 36, wherein the coupling element comprises a pull cable connected to one end of the spring element and to the electromechanical actuator.

38. The massage device as claimed in claim 34, wherein the restoring element has a slip clutch which is driven by a continuously operated electric motor and a pull cable which is connected to the slip clutch and the spring element.

39. The massage device as claimed in claim 34, the restoring element comprises a conical cable roller, which is driven by an electric motor, and a pull cable which can be wound and unwound on the conical cable roller in a manner guided along the lateral surface of the conical cable roller and is connected to one end of the spring element.

40. The massage device as claimed in claim 34, wherein the restoring element has a pull cable which is connected to one end of the spring element and to a cable-winding device, which is configured in such a way that the pull cable can be wound and unwound unevenly to generate a vibration massage effect.

41. The massage device as claimed in claim 34, wherein the restoring element contains a pull cable, which is connected to one end of the spring element and can be wound and unwound on a rack or spindle driven by an electric motor directly or via a flexible spindle.

42. The massage device as claimed in claim 34, wherein the restoring element has a spindle nut, whereof the internal thread meshes with the windings of a spring element formed as a cylinder spring and whereof the external thread meshes with a gearwheel driven by an electric motor in such a way that the cylinder spring is moved back and forth.

43. The massage device as claimed in claim 34, wherein the restoring element comprises a moving coil magnet whereof the coil is connected to one end of the spring element in such a way that, as a result of a magnetic alternating field generated when a current flows through the coil, the coil connected to the spring element is moved upwards and downwards within the magnetic field generated by a permanent magnet of the moving coil magnet.

44. The massage device as claimed in claim 34, wherein a plurality of spring elements are connected to a common electromechanical actuator via coupling elements associated with said spring elements.

45. The massage device as claimed in claim 34, wherein the restoring element has a pull cable which is connected to the electromotive drive via a winding shaft and whereof the ends are connected to at least two spring elements in such a way that, upon actuation of the electromotive drive, the change in shape of the spring elements with respect to the contact surface of the vehicle seat is altered in a mutually opposed direction.

46. The massage device as claimed in claim 34, wherein a plurality of spring elements are connected to a respective coupling element, which has a pull cable, which is connected to one end of the spring elements and can be wound and unwound on a shaft, and a switchable clutch, which connects the shaft to an electromotive drive of the restoring element.

47. The massage device as claimed in claim 34, wherein the spring element can be arrested by means of a locking element in a position which is pre-tensioned by means of the restoring element.

48. The massage device as claimed in claim 34, wherein inactive spring elements of the massage device can be locked by means of a push-push locking mechanism.

49. The massage device as claimed in claim 34, wherein the restoring element has a pull cable whereof one end is connected to one end of the spring element and whereof the other end is connected to a component comprising a shape memory alloy which can be connected to a current source in such a way that the component contracts when a current is applied and expands when a current is not applied for the purpose of contracting and extending the spring element.

50. The massage device as claimed in claim 34, wherein the component comprises a deflection or articulated lever and a shape memory wire connected thereto.

51. The massage device as claimed in claim 34, wherein the restoring element comprises a spring steel element and a component which is connected to the ends of the spring steel element and comprises a shape memory wire which contracts when a current is applied and expands when a current is not applied.

52. The massage device as claimed in claim 34, wherein the massage elements can be pre-set individually in such a way that the contour of the vehicle seat can be adapted to a person using the vehicle seat.

53. The massage device as claimed in claim 34 for use in at least on of
the pad structure of a seat part or a backrest of the vehicle seat,
side bolsters of a seat part, a backrest or a head rest of the vehicle seat,
a device for lumbar adjustment of a vehicle seat and
a thigh support of a vehicle seat.
